(19) United States
(12) Patent Application Publication
(10) Pub. No.: US 2021/0166235 A1
(43) Pub. Date: Jun. 3, 2021

(54) SYSTEM AND METHOD FOR TRANSFERRING AND ROLLING-OVER FUNDS BETWEEN ACCOUNTS

(71) Applicant: Rocket Dollar, Inc., Austin, TX (US)

(72) Inventors: Richard DUDE, Austin, TX (US); Christopher PALMISANO, Austin, TX (US); Ryan MARTINEZ, Austin, TX (US); T. Henry YOSHIDA, Austin, TX (US); Thomas YOUNG, Austin, TX (US)

(73) Assignee: Rocket Dollar, Inc., Austin, TX (US)

(21) Appl. No.: 16/701,057

(22) Filed: Dec. 2, 2019

(51) Int. Cl. G06Q 20/40; G06Q 20/10; G06Q 40/06; H04L 29/08

(52) U.S. Cl. CPC G06Q 20/405; G06Q 20/108; G06Q 20/3825; H04L 67/306; G06Q 2220/00; G06Q 40/06

(57) ABSTRACT

Methods and systems for transferring tax-advantaged retirement account money between tax-advantaged Retirement Accounts at one financial institution to another financial institution are disclosed. The methods may be consumer or merchant driven and may involve transferring between Individual Retirement Accounts (IRAs), Roth IRAs, SEP IRAs, SIMPLE IRAs, Inherited IRAs, or Qualified Plans such as 401(k)s, TSPs, 403(b)s, etc. Based on information input by a user and information gathered from external financial institutions, various technology and financial systems interact in a manner that result in the successful transmission of tax-advantaged retirement account money in a manner that is compliant with IRS regulations in order to prevent a taxable event. Such novel methods allow for automated ways of transferring tax-advantaged retirement account money between financial institutions.

### BACKGROUND OF THE INVENTION

### 1. Field of the Invention

The present invention generally relates to computer systems and methods for transferring tax-advantaged retirement account money between tax-advantaged retirement accounts. Specifically, the present invention relates to methods and computer systems for determining minimum eligibility requirements for transferring funds and creating an interface for account owners to complete in order to transfer funds.

### 2. Description of the Related Art

People frequently transfer cash from one or more tax-advantaged retirement accounts to another retirement account. For example, a user may wish to transfer cash from a 401(k) of a former employer to an IRA or a Roth IRA. Money may be transferred between tax-advantaged retirement accounts without incurring a taxable event if all tax regulations on custody and transfer requirements are followed. Financial institutions receiving transfer requests have specific transfer requirements that must be followed so the transfer is not rejected by them, in order to prevent fraud and reduce liability for fraudulent transfers. Therefore, the transfer request must be submitted in a way following these specific transfer requirements. The obligation to discover these requirements and the appropriate method of submission is conventionally upon the user to understand. In another example, a user may wish to transfer cash from a SIMPLE IRA to a Traditional IRA. The user needs to research the IRS regulations for the transfer to determine that this transfer is possible without incurring a taxable event, and if not, to avoid the transfer, thus saving the user money by not triggering the taxable event. Any mistake in the process would potentially incur a taxable event.

One existing method of transferring cash between tax-advantaged retirement accounts in a way that does not trigger a taxable event is with the Automated Customer Account Transfer Service (ACATS) system. ACATS is primarily for transfer of securities from one trading account to another, and as such can be used for moving cash and securities between tax-advantaged retirement accounts. However, in order to use the ACATS system, both the sending and receiving financial institution must be a member of the National Securities Clearing Corporation (NSCC). There is significant cost in both fees from NSCC and obtaining the technology necessary to utilize the ACATS system. Additionally, ACATS itself has limitations, as transfers can only happen between like accounts. For instance, while the IRS will allow a rollover from a SIMPLE IRA to a Traditional IRA without triggering a taxable event, the ACATS system does not support this.

Accordingly, there remains a continuing need for a method that allows users to transfer cash between tax-advantaged retirement accounts without triggering taxable events.

### SUMMARY OF THE INVENTION

The present invention generally relates to computer systems and methods for transferring tax-advantaged retirement account money between tax-advantaged retirement accounts. Specifically, the present invention relates to computer systems and methods for initiating and tracking the transfer of tax-advantaged money from one tax-advantaged retirement account to another tax-advantaged retirement account, such as a Traditional Individual Retirement Account (IRA), Roth IRA, SEP IRA, SIMPLE IRA, Inherited IRA, 401(k), 403(b), Thrift Savings Plan (TSP), or other tax-advantaged retirement account.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The innovation disclosed and claimed herein relates to methods, systems and computer readable storage media that allow transferring tax-advantaged retirement account money between tax-advantaged retirement accounts. The methods may be consumer or merchant driven and may involve transferring tax-advantaged retirement account money between Traditional Individual Retirement Accounts (IRAs), Roth IRAs, SEP IRAs, SIMPLE IRAs, Inherited IRAs, 401(k)s, 403(b)s, Thrift Savings Plan (TSP)s, or any other transfers or money between tax-advantaged retirement accounts. For example, in one aspect, tax-advantaged retirement account money is transferred from a SIMPLE IRA to a Traditional IRA by verifying with the user that two years have passed since the first contribution to the SIMPLE IRA, taking input of the transfer amount from the user, verifying that the transfer is indeed a full transfer, and taking input of the source account number for the SIMPLE IRA from the user, thereby initiating the direct transfer process.

The initiated direct transfer process would then query a proprietary database of custodian transfer requirements, analyze whether the transfer amount is above the original form amount threshold, analyze whether the transfer amount is above the wet signature amount threshold, and analyze whether the transfer amount is above the medallion signature guarantee amount threshold. The process would then perhaps determine that while the transfer amount is below the medallion signature guarantee threshold and below the original form amount threshold, the transfer amount is above the wet signature amount threshold for the custodian of the account from which the tax-advantaged retirement account money is being transferred. As such, the process would retrieve the valid fax number of the custodian and initiate the direct transfer using the wet signature and electronic submission sub-process.

The wet signature and electronic submission sub-process would then generate a transfer request form electronically using all account details and transfer details for the user generating the transfer including the user's destination account number, full name, address, social security number, the source account type (which is in this example a SIMPLE IRA), the destination account type (which is in this example a Traditional IRA), the estimated amount of the transfer, and the fact that the transfer is a full transfer. The transfer request form would also be generated using the receiving custodian's address in order to receive a check, or if the user indicates, the receiving custodian's routing number in order to receive a wire transfer or a direct transfer through the automated clearing house (ACH). The transfer request form would further be generated using the receiving custodian's phone number and any legal language necessary to indemnify the custodian of the account that is the source of funds.

This form would be presented to the user for electronic signature, and then once the user signs the form electronically, this form would be presented to the receiving or winning custodian for counter-signature, and then be electronically faxed to the outgoing or losing custodian using the fax number retrieved from the proprietary database. By following this process, this transfer request from a SIMPLE IRA to a Traditional IRA now follows all IRS rules regarding transferring money between tax-advantaged retirement accounts without triggering a tax event, as well as follows all compliance requirements of the custodian holding the account from which funds are being transferred. In this example, the amount of the transfer requires a wet signature and will be accepted via fax, and is therefore guaranteed to be fulfilled following this process assuming that the funds are available in the account from which funds are being transferred.

In one aspect, the funding account may be a Traditional IRA, a Roth IRA, a SEP IRA, a SIMPLE IRA, an Inherited IRA, an Inherited Roth IRA, a qualified plan such as a 401(k), 403(b), Thrift Savings Plan (TSP), the designated Roth account of a qualified plan, the Traditional IRA of a deceased individual, the Roth IRA of a deceased individual, the qualified plan of a deceased individual, the SIMPLE IRA of a deceased individual, or the SEP IRA of a deceased individual, while the receiving account may be a Traditional IRA, a Roth IRA, a SEP IRA, an Inherited Traditional IRA, or an Inherited Roth IRA.

In another aspect, the transfer request is generated by the system and downloaded and printed by the user and signed manually using an ink pen. Then the document is uploaded to the system via photocopy, a digital photo produced through a camera on a mobile device, or a digital photo produced from the webcam of a laptop computer or desktop computer, and transmitted to the losing custodian through an electronic fax. In another aspect this same transfer request is submitted to the custodian holding the account through an electronic fax and signed electronically by the user using an electronic signature process on their laptop computer, desktop computer, or mobile phone. In another aspect, the transfer request is generated by the system and downloaded and printed by the user, signed manually using an ink pen in front of a bank official with a medallion signature guarantee, and the medallion stamp is applied. Then the transfer form is mailed in original form to the receiving financial institution, the document counter-signed, and the transfer form is mailed to the losing custodian. The system provides electronic updates as to the status of the transfer request at each juncture.

In another aspect, the innovation allows for the rollover of funds from a qualified plan such as a 401(k), 403(b), Thrift Savings Plan (TSP), or other qualified plan to a Traditional IRA by retrieving the account number and exact amount of money being rolled over to the Traditional IRA from the qualified plan. This data is then input along with the account holder's name, account holder's address, account holder's social security number, the destination account type (which is in this case a Traditional IRA), and the destination account number onto a rollover certification form. The rollover certification form is then presented to the user for electronic signature, and then submitted to the winning custodian for processing. The system then provides the user with instructions for submitting the rollover funds, for example either by check, by wire, or by ACH, to the winning custodian, and notifies both the user and the winning custodian as to the status of the rollover at each juncture.

According to exemplary embodiments, a method of transferring funds from a first account to a second account is provided. The method includes determining dynamically a first set of eligibility criteria for a first financial institution controlling the first account. The first set of eligibility criteria are first minimum requirements for a transfer of funds out of the first account. The method further includes determining dynamically a second set of eligibility criteria for a second financial institution controlling the second account. The second set of eligibility criteria are second minimum requirements for a transfer of funds in to the second account. The method also includes communicating, to an account owner of the first account, a transaction interface. The transaction interface satisfies the first and second sets of eligibility criteria.

The operation of determining dynamically the first set of eligibility criteria may include periodically accessing a first database of the first financial institution, and the operation of determining dynamically the second set of eligibility criteria may include periodically accessing a second database of the second financial institution.

In exemplary embodiments of the method, the operation of determining dynamically the first set of eligibility criteria includes periodically accessing a database of transfer-out requirements. The first financial institution may be incentivized to update the database of transfer-out requirements. The operation of determining dynamically the second set of eligibility criteria may include periodically accessing a database of transfer-in requirements. The second financial institution may be incentivized to update the database of transfer-in requirements.

In further exemplary embodiments of the method, the operation of providing the transaction interface includes an indication of a requirement of at least one of a medallion signature guarantee, an e-signature, and a wet signature. The requirement may be one of the first minimum requirements and/or the second minimum requirements.

The requirement may be of the e-signature, and the method may further include accessing a third-party verification engine for verifying the e-signature.

The operation of providing the transaction interface may include an indication of a requirement of at least one of an original and a fax.

The exemplary method may include receiving information input into the transaction interface by the account owner.

Additional exemplary embodiments of the method include initiating a transfer of funds from the first account to the second account.

Further exemplary methods according to the present invention include encrypting communications to the account owner, encrypting communications from the account owner, encrypting communications to the first financial institution, and encrypting communications to the second financial institution.

The first set of eligibility criteria may include a first amount threshold, a minimum holding period for the first account, a first set of qualifying account types of the first account, and a second set of qualifying account types of the second account. The second set of eligibility criteria may include a second amount threshold, a third set of qualifying account types of the first account and a fourth set of qualifying account types of the second account.

An exemplary system for transferring funds from a first account to a second account is provided. The exemplary system includes a first determining arrangement for determining dynamically a first set of eligibility criteria for a first financial institution controlling the first account. The first set of eligibility criteria are first minimum requirements for a transfer of funds out of the first account. The exemplary system further includes a second determining arrangement for determining dynamically a second set of eligibility criteria for a second financial institution controlling the second account. The second set of eligibility criteria are second minimum requirements for a transfer of funds in to the second account. The exemplary system also includes a transaction interface generator adapted to generate a transaction interface satisfying the first and second sets of eligibility criteria. The transaction interface generator is further adapted to communicate the transaction interface to an account owner of the first account.

The exemplary system may include a first database access arrangement adapted to periodically access a first database of the first financial institution to determine dynamically the first set of eligibility criteria, and may also include a second database access arrangement adapted to periodically access a second database of the second financial institution to determine dynamically the second set of eligibility criteria.

The system according to an exemplary embodiment of the present technology may also include a first incentivizing arrangement for incentivizing the first financial institution to update a database of transfer-out requirements. The first determining arrangement may periodically access the database of transfer-out requirements to determine dynamically the first set of eligibility criteria. The system may further include a second incentivizing arrangement for incentivizing the second financial institution to update a database of transfer-in requirements. The second determining arrangement may periodically access the database of transfer-in requirements to determine dynamically the second set of eligibility criteria.

The transaction interface may include an indication of a requirement of at least one of a medallion signature guarantee, an e-signature, and a wet signature.

When the requirement is of the e-signature, the exemplary system may include an application programming interface for accessing a third-party verification engine, the third-party verification engine for verifying the e-signature.

The transaction interface may include an indication of a requirement of at least one of an original and a fax.

In an exemplary system, information input into the transaction interface may be received by the account owner, and a transfer of funds from the first account to the second account may be initiated.

A non-transitory computer readable medium having stored thereon software instructions is provided according to the present technology. When executed by a processor, the software instructions cause the processor to perform exemplary methods according to the present technology for transferring funds from a first account to a second account.

Particular illustrations are described in connection with the following descriptions and the annexed drawings. These illustrations are indicative, however, of but a few of the various ways in which the principles of the innovation can be employed. Other advantages will be readily apparent from the detailed description that follows. The subject innovation is intended to include all aspects and equivalents.

### BRIEF DESCRIPTION OF THE DRAWINGS

The accompanying drawing figures incorporated in and forming a part of this specification illustrate several aspects of the invention and together with the description serve to explain the principles of the invention.

FIG. 1A illustrates a system for presenting valid source account types which can transfer cash to the user's currently selected tax-advantaged account without incurring a taxable event.

FIG. 1B is a flow diagram of a routine for determining the correct transfer process to be used when a Traditional IRA is the destination account type.

FIG. 1C is a flow diagram of a routine for determining the correct transfer process to be used when a Roth IRA is the destination account type.

FIG. 1D is a flow diagram of a routine for determining the correct transfer process to be used when an Inherited (aka Beneficiary) Traditional IRA is the destination account type.

FIG. 1E is a flow diagram of a routine for determining the correct transfer process to be used when an Inherited (aka Beneficiary) Roth IRA is the destination account type.

FIG. 1F is a flow diagram of a routine for determining the correct transfer process to be used when a SEP IRA is the destination account type.

FIG. 2 illustrates a system for interrogating a proprietary database of transfer requirements of various custodians holding tax-advantaged accounts in order to initiate the appropriate method of transfer to ensure transfer request acceptance.

FIG. 3A illustrates a sub-system for capturing an electronic signature and submitting a transfer request electronically. The system in FIG. 2 selects and initiates this sub-system.

FIG. 3B illustrates a sub-system for capturing a wet signature and submitting a transfer request electronically. The system in FIG. 2 selects and initiates this sub-system.

FIG. 3C illustrates a sub-system for capturing an original signature and submitting the original transfer request. The system in FIG. 2 selects and initiates this sub-system.

FIG. 3D illustrates a sub-system for capturing electronic signature and submitting a rollover certification electronically. The system in FIG. 2 selects and initiates this sub-system.

FIG. 4 is a flow chart illustrating an exemplary method according to the present invention.

FIG. 5 is a schematic diagram of a computing system used in an exemplary embodiment of the present invention.

FIG. 6 is a schematic diagram of a computing network used in an exemplary embodiment of the present invention.

### DETAILED DESCRIPTION OF THE INVENTION

The present invention can be better understood from the following description of preferred embodiments, taken in conjunction with the accompanying drawings. It should be apparent to those skilled in the art that the described embodiments of the present invention provided herein are merely exemplary and illustrative, and not limiting.

The present invention is directed to systems and methods for transferring cash between tax-advantaged retirement accounts. The user-selected destination account also may be referred to as a receiving account. The custodian who custodies the receiving account may be referred to as the winning custodian. The user-selected source account also may be referred to as the sending account. The custodian who custodies the sending account may be referred to as the losing custodian. The money being transferred may be cash. The method of transmission may be any acceptable method of transmitting cash between financial institutions, namely through wire transfer, Automated Clearing House (ACH), or check.

Sending accounts may take various forms in different embodiments of the invention. In one embodiment, the sending account is an Individual Retirement Account (IRA). Examples of such IRAs are Traditional IRAs, Roth IRAs, SEP IRAs, SIMPLE IRAs, Inherited IRAs, Inherited Roth IRAs, and all of said accounts who have been previously owned by a deceased individual and are in conservatorship of another living person. In another embodiment, the sending account is a Qualified Plan. Examples of such Qualified Plans are 401(k)s, 403(b)s, Thrift Savings Plans (TSP), and any other qualified retirement plan as defined by the IRS. In a similar embodiment, the sending account is the designated Roth account of a Qualified Plan. Receiving accounts as described in this invention are Traditional IRAs, Roth IRAs, SEP IRAs, Inherited IRAs, and Inherited Roth IRAs.

In accordance with the present invention, a transfer request is a machine generated document which is submitted to the losing custodian either by fax, mail, email or any other appropriate method by a transfer request service after execution by the user and the winning custodian. The transfer request service facilitates the correct submission method and eligibility determination of a transfer between tax-advantaged retirement accounts without incurring a taxable event and ensuring acceptance of the transfer request per the transfer request submission compliance requirements of the losing custodian. The transfer request service provides instructions to a consumer device and collects transfer information and provides the transfer information and transfer instructions to the consumer device. The consumer device communicates the transfer information and transfer instructions to the transfer request service, which generates the appropriate and completed transfer request document and presents it to the user for execution, either electronically or physically as mandated by the losing custodian. The transfer request service may additionally provide a Medallion Signature Guarantee (MSG) if mandated by the losing custodian. The transfer request system then communicates the transfer information and transfer instructions to the winning custodian and presents the user-executed transfer request document, either in original or digital form, to the winning custodian for counter-execution either electronically or physically as mandated by the losing custodian. The transfer request service may additionally provide a Medallion Signature Guarantee (MSG) if mandated by the losing custodian. After the transfer request is executed by both the winning custodian and the user, and the MSG is added where appropriate, the transfer request service acts as a transmitter of the instruction to the losing custodian via the appropriate submission method as determined by the losing custodian. The transfer request instruction is then honored by the losing custodian and funds are transmitted to the winning custodian through the Automated Clearing House (ACH), a wire transfer, or by mailing a check to the address of the winning custodian as retrieved from the transfer request system.

Using the transfer service, a transfer between unlike tax-advantaged retirement accounts, such as from a SEP IRA to a Traditional IRA, can be initiated, which is not possible using the existing ACATs transfer system. In such an embodiment, the user submits account details for the SEP IRA account held at the losing custodian and the account details for the Traditional IRA account held at the winning custodian. Based on the user-input information, the transfer service looks up the transfer request requirements of the losing custodian and correctly generates a transfer request document to be executed by the winning custodian and the user. The system submits the request to the losing custodian. When the losing custodian receives the transfer request instruction, they note all the details of the mutual user between the losing custodian and winning custodian, as well as the transfer funding instructions enclosed in the document, and initiate the transfer of cash from the SEP IRA custodied at their institution to the Traditional IRA at the winning custodian per the received instruction.

The transfer service may also facilitate rollover of funds from a qualified retirement plan to an IRA. The user provides data points such as the exact amount of the rollover check from the plan custodied by the losing custodian, the source account identifier, which may be an account number or some other identifier like a Social Security Number of the plan participant, the account holder's name, the account holder's address, the account holder's social security number, the destination account type, and the destination account number.

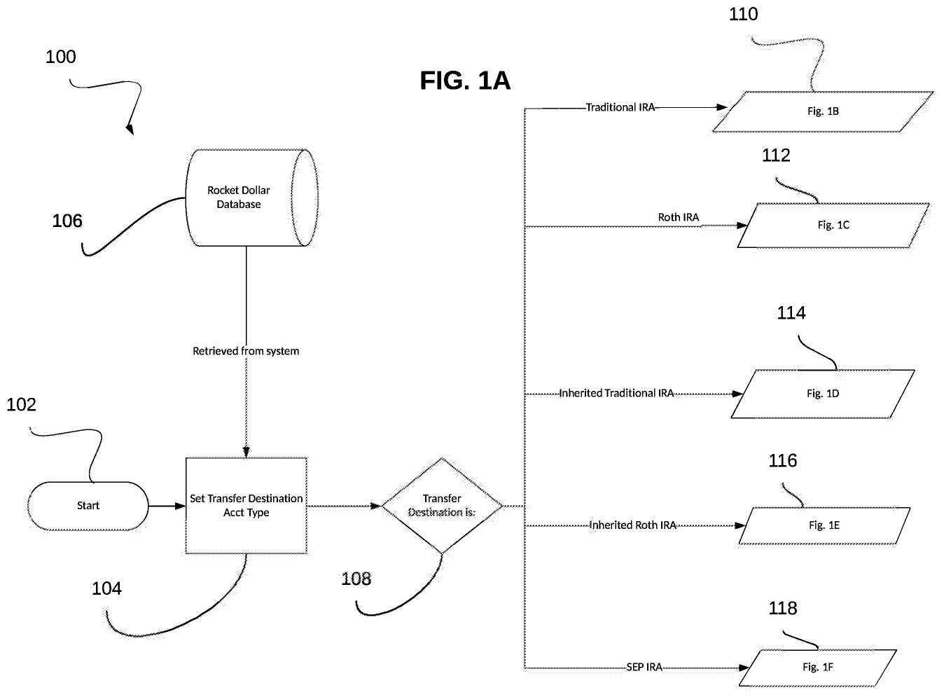

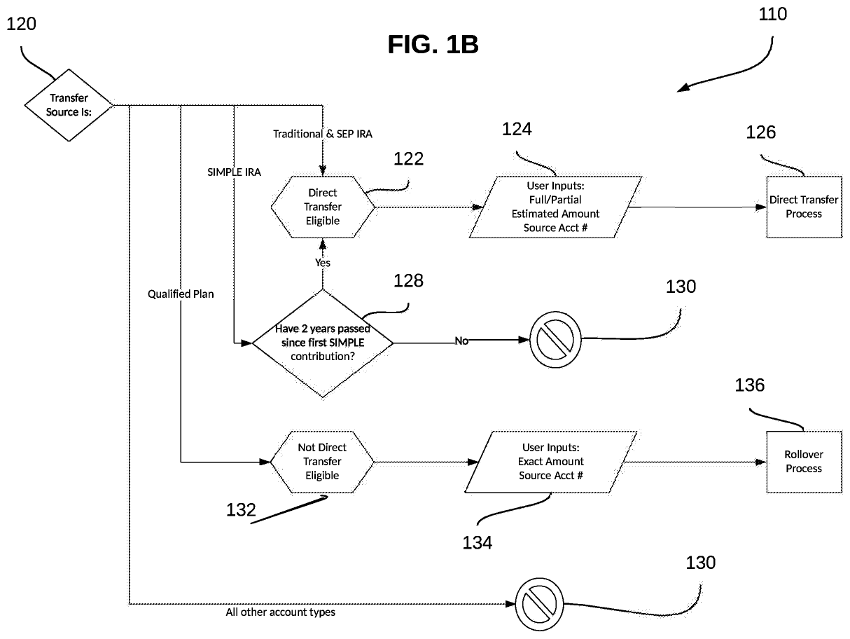

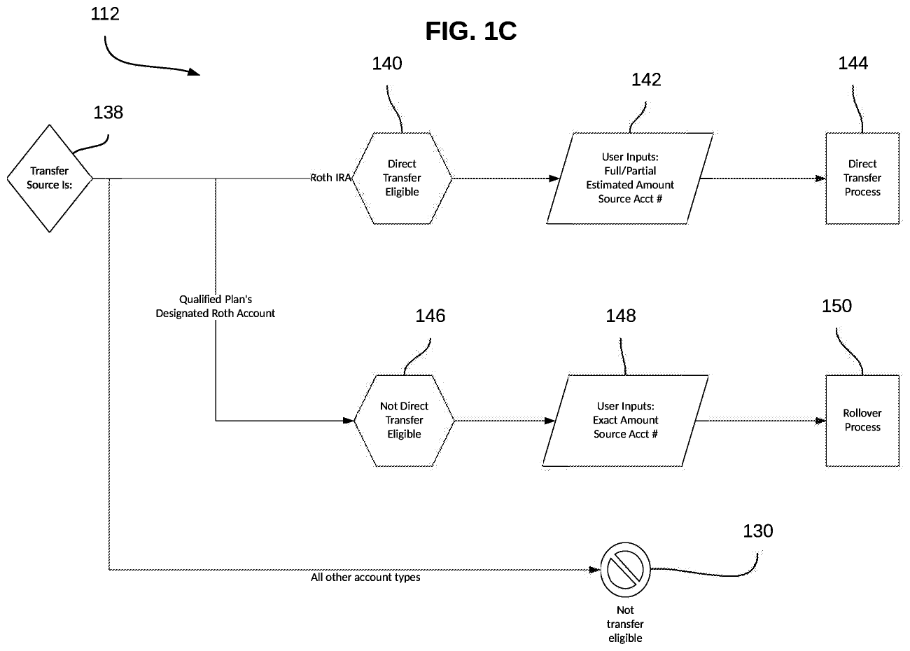

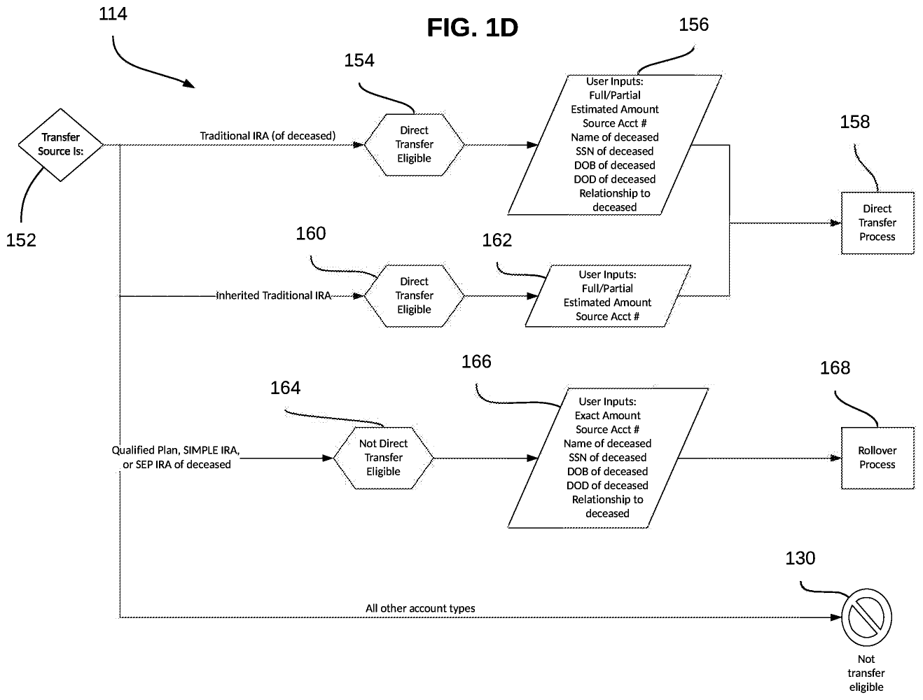

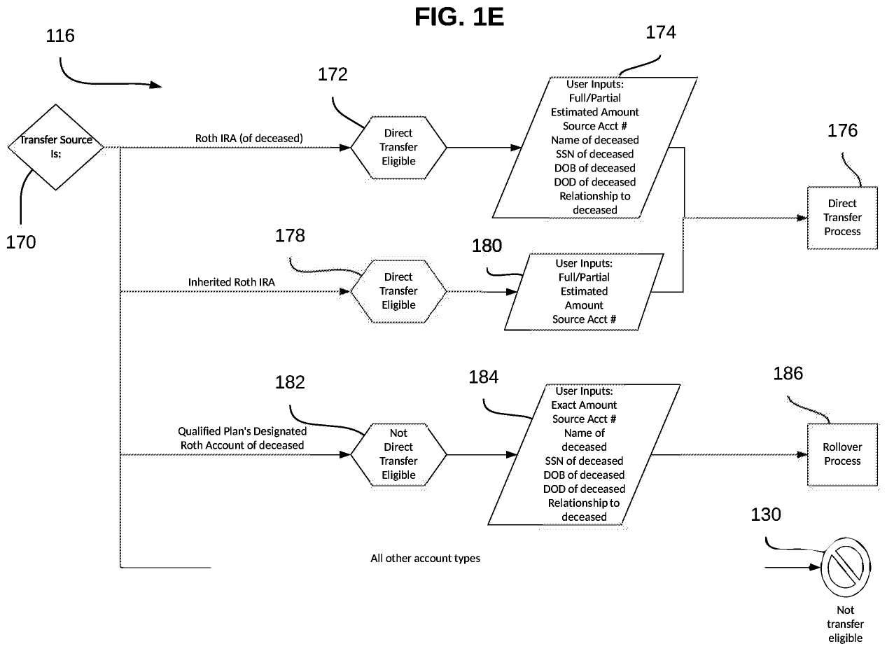

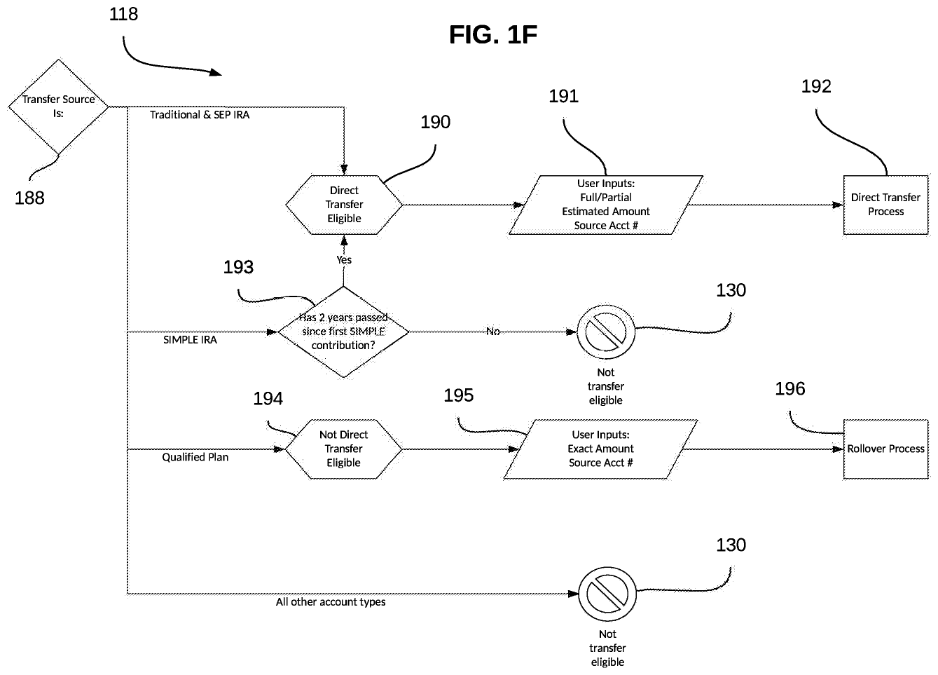

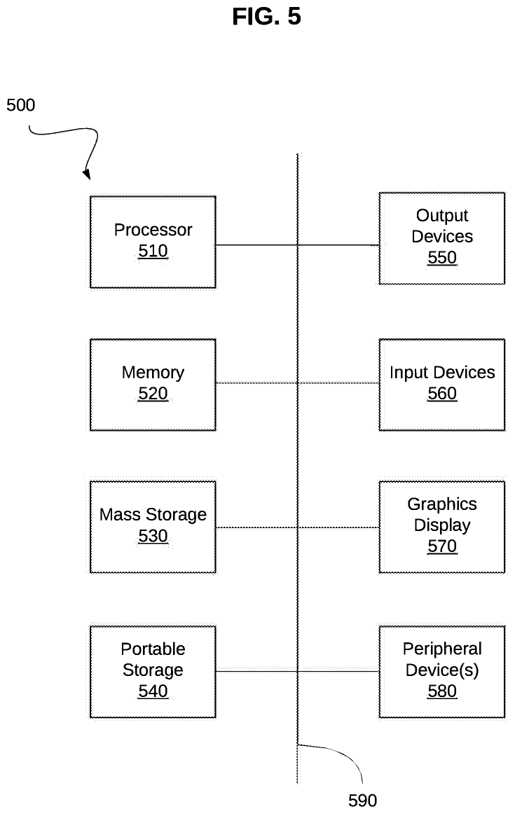

FIG. 1A shows system-flow 100 for presenting valid source account types which can transfer cash to the user's currently selected tax-advantaged account with incurring a taxable event. System-flow 100 begins at start oval 102 and proceeds to operation 104 which indicates to request to the user to set the transfer destination account type. Information necessary for providing options and/or an interface to a user for performing operation 104 may be obtained from database 106 via a network or computing system according to that shown in FIG. 5. From operation 104, the flow proceeds to query 108, which indicates a user response indicating the transfer destination account type. If the answer to query 108 is a Traditional IRA, the flow proceeds to flow 110, which is illustrated in FIG. 1B. If the answer to query 108 is a Roth IRA, the flow proceeds to flow 112, which is illustrated in FIG. 1C. If the answer to query 108 is an Inherited Traditional IRA, the flow proceeds to flow 114, which is illustrated in FIG. 1D. If the answer to query 108 is an Inherited Roth IRA, the flow proceeds to flow 116, which is illustrated in FIG. 1E. If the answer to query 108 is a SEP IRA, the flow proceeds to flow 118, which is illustrated in FIG. 1F.

FIG. 1B shows flow 110 for determining the correct transfer process to be used when a Traditional IRA is the destination account type. Flow 110 begins at query 120, which asks what type of account the transfer source is. If the answer to query 120 is a Traditional and SEP IRA, the flow proceeds to determination 122, which indicates that the transfer is eligible for a direct transfer. From determination 122, the flow proceeds to input 124, which indicates that the user inputs whether the transfer is full or partial, if partial an estimated amount, and a source account number. From input 124, the flow proceeds to operation 126, which indicates to perform the direct transfer. If the answer to query 120 is a SIMPLE IRA, the flow proceeds to query 128, which asks if two years have passed since the first contribution to the SIMPLE IRA. If the answer to query 128 is affirmative, the flow in flow 110 proceeds to determination 122. If the answer to query 128 is negative, the flow in flow 110 proceeds to disallowed transfer indication 130. If the answer to query 120 is a Qualified Plan, the flow proceeds to determination 132, which indicates that the transfer is not eligible for a direct transfer. From determination 132, the flow proceeds to input 134, which indicates that the user inputs an exact amount of the transfer and a source account number. From input 134, the flow proceeds to operation 136, which indicates to perform the rollover. For all other account types input in response to query 120, the flow proceeds to disallowed transfer indication 130.

FIG. 1C shows flow 112 for determining the correct transfer process to be used when a Roth IRA is the destination account type. Flow 112 begins at query 138, which asks what type of account the transfer source is. If the answer to query 138 is a Roth IRA, the flow proceeds to determination 140, which indicates that the transfer is eligible for a direct transfer. From determination 140, the flow proceeds to input 142, which indicates that the user inputs whether the transfer is full or partial, if partial an estimated amount, and a source account number. From input 142, the low proceeds to operation 144, which indicates to perform the direct transfer. If the answer to query 138 is a Qualified Plan's Designated Roth Account, the flow proceeds to determination 146, which indicates that the transfer is not eligible for a direct transfer. From determination 146, the flow proceeds to input 148, which indicates that the user inputs an exact amount of the transfer and a source account number. From input 148, the flow proceeds to operation 150, which indicates to perform the rollover. For all other account types input in response to query 138, the flow proceeds to disallowed transfer indication 130.

FIG. 1D shows flow 114 for determining the correct transfer process to be used when an Inherited (aka Beneficiary) Traditional IRA is the destination account type. Flow 114 begins at query 152, which asks what type of account the transfer source is. If the answer to query 152 is a Traditional IRA (of the deceased), the flow proceeds to determination 154, which indicates that the transfer is eligible for a direct transfer. From determination 154, the flow proceeds to input 156, which indicates that the user inputs whether the transfer is full or partial, if partial an estimated amount, a source account number, and various information related to the deceased person. From input 156, the flow proceeds to operation 158, which indicates to perform the direct transfer. If the answer to query 152 is an Inherited Traditional IRA, the flow proceeds to determination 160, which indicates that the transfer is eligible for a direct transfer. From determination 160, the flow proceeds to input 162, which indicates that the user inputs whether the transfer is full or partial, if partial an estimated amount, and a source account number. From input 162, the flow proceeds to operation 158, which indicates to perform the direct transfer. If the answer to query 152 is a Qualified Plan, SIMPLE IRA or SEP IRA of the deceased, the flow proceeds to determination 164, which indicates that the transfer is not eligible for a direct transfer. From determination 164, the flow proceeds to input 166, which indicates that the user inputs whether the transfer is full or partial, if partial an estimated amount, a source account number, and various information related to the deceased person. From input 166, the flow proceeds to operation 168, which indicates to perform the rollover. For all other account types input in response to query 152, the flow proceeds to disallowed transfer indication 130.

FIG. 1E shows flow 116 for determining the correct transfer process to be used when an Inherited (aka Beneficiary) Roth IRA is the destination account type. Flow 116 begins at query 170, which asks what type of account the transfer source is. If the answer to query 170 is a Roth IRA (of the deceased), the flow proceeds to determination 172, which indicates that the transfer is eligible for a direct transfer. From determination 172, the flow proceeds to input 174, which indicates that the user inputs whether the transfer is full or partial, if partial an estimated amount, a source account number, and various information related to the deceased person. From input 174, the flow proceeds to operation 176, which indicates to perform the direct transfer. If the answer to query 170 is an Inherited Roth IRA, the flow proceeds to determination 178, which indicates that the transfer is eligible for a direct transfer. From determination 178, the flow proceeds to input 180, which indicates that the user inputs whether the transfer is full or partial, if partial an estimated amount, and a source account number. From input 180, the flow proceeds to operation 176, which indicates to perform the direct transfer. If the answer to query 170 is a Qualified Plan's Designated Roth Account of the deceased, the flow proceeds to determination 182, which indicates that the transfer is not eligible for a direct transfer. From determination 182, the flow proceeds to input 184, which indicates that the user inputs whether the transfer is full or partial, if partial an estimated amount, a source account number, and various information related to the deceased person. From input 184, the flow proceeds to operation 186, which indicates to perform the rollover. For all other account types input in response to query 170, the flow proceeds to disallowed transfer indication 130.

FIG. 1F shows flow 118 for determining the correct transfer process to be used when a SEP IRA is the destination account type. Flow 118 begins at query 188, which asks what type of account the transfer source is. If the answer to query 188 is a Traditional or SEP IRA, the flow proceeds to determination 190, which indicates that the transfer is eligible for a direct transfer. From determination 190, the flow proceeds to input 191, which indicates that the user inputs whether the transfer is full or partial, if partial an estimated amount, a source account number, and various information related to the deceased person. From input 191, the flow proceeds to operation 192, which indicates to perform the direct transfer. If the answer to query 188 is an SIMPLE IRA, the flow proceeds to query 193, which asks if two years have passed since the first contribution to the SIMPLE IRA. If the answer to query 193 is affirmative, the flow in flow 118 proceeds to determination 190 and then proceeds as discussed above. If the answer to query 193 is negative, the flow in flow 118 proceeds to disallowed transfer indication 130. If the answer to query 188 is a Qualified Plan, the flow proceeds to determination 194, which indicates that the transfer is not eligible for a direct transfer. From determination 194, the flow proceeds to input 195, which indicates that the user inputs an exact amount of the transfer and a source account number. From input 195, the flow proceeds to operation 196, which indicates to perform the rollover. For all other account types input in response to query 188, the flow proceeds to disallowed transfer indication 130.

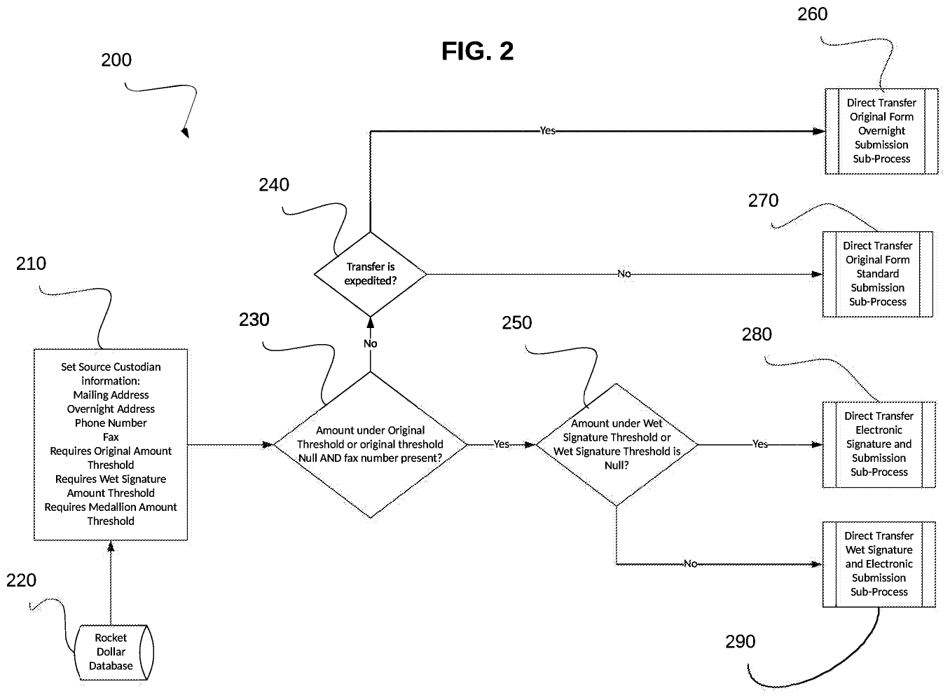

FIG. 2 illustrates system-flow 200 for interrogating a proprietary database of transfer requirements of various custodians holding tax-advantaged accounts in order to initiate the appropriate method of transfer to ensure transfer request acceptance. System-flow 200 begins at operation 210 which indicates to set source custodian information including mailing address, overnight address, phone number, fax, the threshold amount for requiring an original copy of the request, the threshold amount for requiring a wet signature, and the threshold amount for requiring a Medallion. Information necessary for providing options and/or an interface to a user for performing operation 210 may be obtained from database 220 via a network or computing system according to that shown in FIG. 5. From operation 210, the flow proceeds to query 230, which asks whether the amount is under the threshold for requiring an original copy of the request, the original threshold is null, and a fax number is present. If the response to query 230 is negative, the flow proceeds to query 240, which asks whether the transfer is expedited. If the response to query 240 is affirmative, the flow proceeds to action 260, which indicates to direct the transfer using the original form for overnight submission. If the response to query 240 is negative, the flow proceeds to action 270, which indicates to direct the transfer using the original form for standard submission. If the response to query 230 is affirmative, the flow proceeds to query 250, which asks whether the amount is under the wet signature threshold or if the wet signature threshold is null. If the response to query 250 is affirmative, the flow proceeds to action 280, which indicates to direct the transfer using an electronic signature for the submission. If the response to query 250 is negative, the flow proceeds to action 290, which indicates to direct the transfer using a wet signature for the submission.

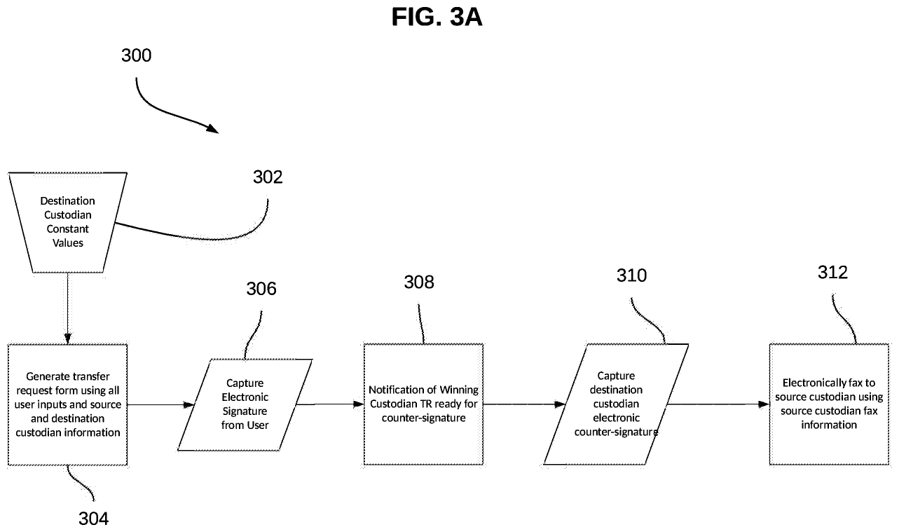

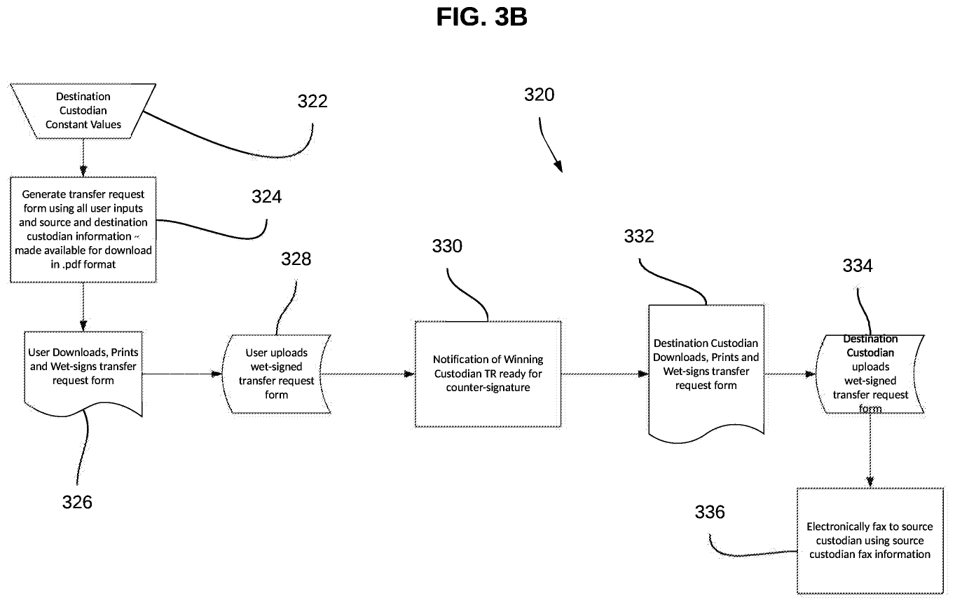

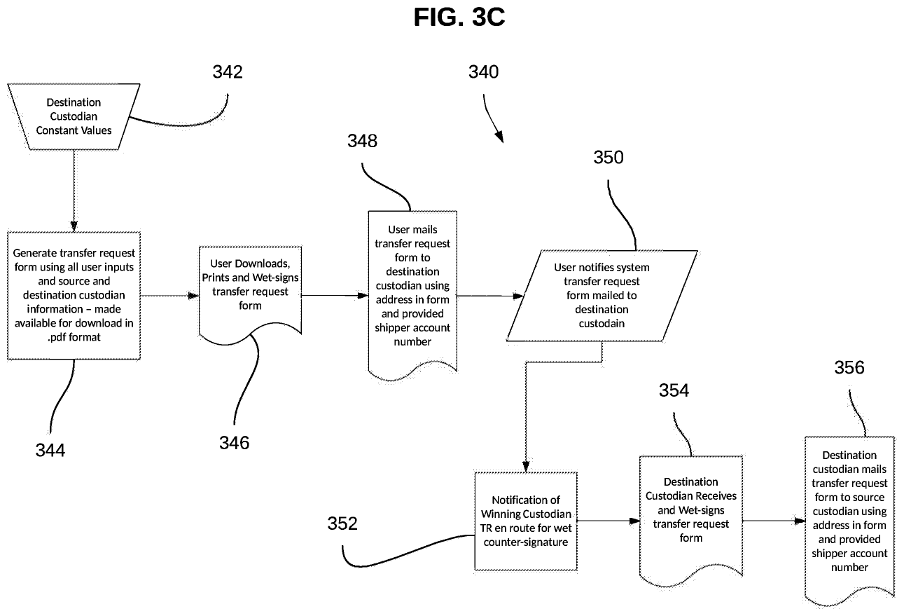

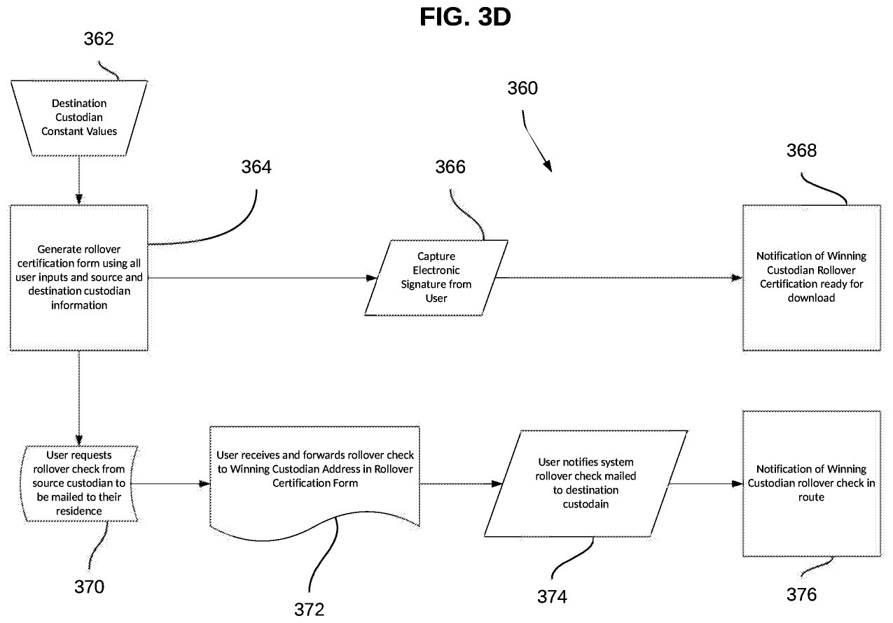

FIG. 3A illustrates sub-system 300 for capturing an electronic signature and submitting a transfer request electronically. System-flow 200 in FIG. 2 selects and initiates sub-system 300, which proceeds from action 280 in FIG. 2. Sub-system 300 begins with inputs 302, which include destination and custodian information. The custodian information, such as the custodian's name, address, fax number, phone number, overnight mail address, etc., may be constant. These values may be input at the beginning of the process from a database and not change through this process. From inputs 302, the flow proceeds to operation 304, which indicates to generate a transfer request form using all user inputs and source and destination custodian information. From operation the 304, the flow proceeds to operation 306, which indicates to capture an electronic signature from the user. From operation 306, the flow proceeds to operation 308, which indicates to notify the winning custodian of the transfer request (also referred to herein as TR), and to indicate readiness for a counter-signature. From operation 308, the flow proceeds to operation 310, which indicates to capture an electronic counter-signature of the destination custodian. From operation 310, the flow proceeds to operation 312, which indicates to electronically fax to the source custodian using the source custodian fax information.

FIG. 3B illustrates sub-system 320 for capturing a wet signature and submitting a transfer request electronically. System-flow 200 in FIG. 2 selects and initiates sub-system 320, which proceeds from action 290 in FIG. 2. Sub-system 320 begins with inputs 322, which include destination and custodian information. From inputs 322, the flow proceeds to operation 324, which indicates to generate a transfer request form using all user inputs and source and destination custodian information. This transfer request would be downloadable and printable. From operation the 324, the flow proceeds to operation 326, which indicates that the user downloads, prints, and wet-signs (e.g., using ink) the transfer request form. From operation 326, the flow proceeds to operation 328, which indicates that the user uploads an image of the wet-signed transfer request form. From operation 328, the flow proceeds to operation 330, which indicates to notify the winning custodian of the transfer request, and to indicate readiness for a counter-signature. From operation 330, the flow proceeds to operation 332, which indicates that the destination custodian downloads, prints and wet-signs the transfer request form. From operation 332, the flow proceeds to operation 334, which indicates that the destination custodian uploads an image of the wet-signed transfer request form. From operation 334, the flow proceeds to operation 336, which indicates to electronically fax to the source custodian using the source custodian fax information.

FIG. 3C illustrates sub-system 340 for capturing an original signature and submitting the original transfer request. System-flow 200 in FIG. 2 selects and initiates sub-system 340, which proceeds from action 270 in FIG. 2. Sub-system 340 begins with inputs 342, which include destination and custodian information. From inputs 342, the flow proceeds to operation 344, which indicates to generate a transfer request form using all user inputs and source and destination custodian information. This transfer request would be downloadable and printable. From operation the 344, the flow proceeds to operation 346, which indicates that the user downloads, prints, and wet-signs (e.g., using ink) the transfer request form. From operation 346, the flow proceeds to operation 348, which indicates that the user mails the wet-signed transfer request form. From operation 348, the flow proceeds to operation 350, which indicates that the user notifies the system that the transfer request has been mailed. From operation 350, the flow proceeds to operation 352, which indicates to notify the winning custodian of the transfer request, and to indicate readiness for a wet counter-signature. From operation 352, the flow proceeds to operation 354, which indicates that the destination custodian receive and wet-signs the transfer request form. From operation 354, the flow proceeds to operation 356, which indicates that the destination custodian mails of the wet-signed transfer request form to the source custodian. A similar process to that shown in FIG. 3C proceeds from action 260 in FIG. 2, with the main difference between this subprocess and the overnight process being the use of overnight mail vs. first class mail, which may necessitate using a different overnight mailing address for the losing custodian.

FIG. 3D illustrates sub-system 360 for capturing an electronic signature and submitting a rollover certification electronically. Sub-system 360 begins with inputs 362, which include destination and custodian information. From inputs 362, the flow proceeds to operation 364, which indicates to generate a rollover request certification form using all user inputs and source and destination custodian information. From operation the 364, the flow branches into two directions. A first direction from operation 364 proceeds to operation 366, which indicates to capture an electronic signature of the user. From operation 366, the flow in the first branch proceeds to operation 368, which indicates to notify the winning custodian that the rollover certification is ready to be downloaded. A second direction from operation 364 proceeds to operation 370, which indicates to request by the user a rollover check from the source custodian to be mailed to their residence. From operation 370, the flow in the second branch proceeds to operation 372, which indicates that the user receives and forwards the rollover check to the winning custodian. From operation 372, the flow proceeds in the second branch to operation 374, which indicates that the user notifies the system that the rollover check has been mailed to the destination custodian. From operation 374, the flow in the second branch proceeds to operation 376, which indicates to notify the winning custodian that the rollover check is enroute.

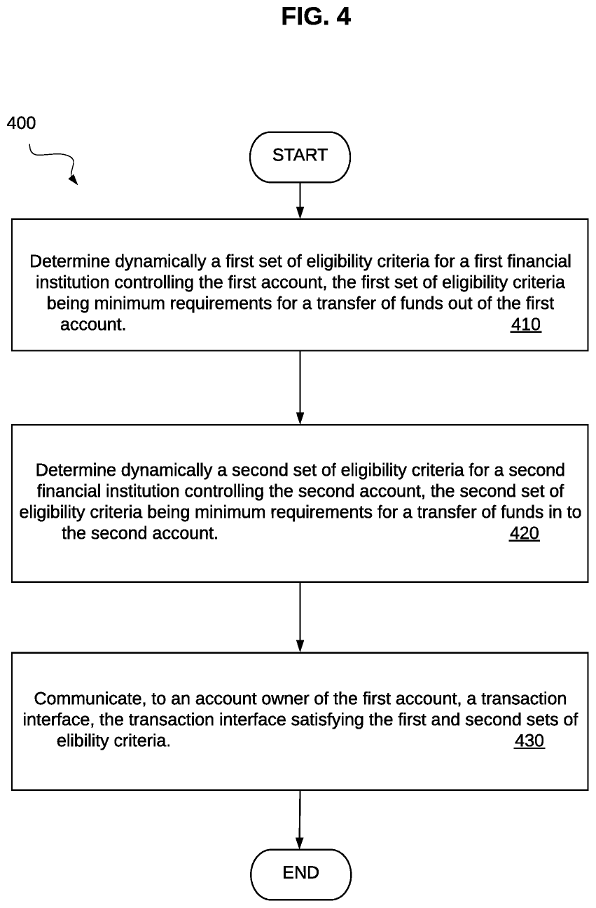

FIG. 4 is a flow chart illustrating method 400 according to the present invention. The flow in method 400 flows from the start oval to operation 410, which indicates to determine dynamically a first set of eligibility criteria for a first financial institution controlling the first account, the first set of eligibility criteria being minimum requirements for a transfer of funds out of the first account. From operation 410, the flow in method 400 proceeds to operation 420, which indicates to determine dynamically a second set of eligibility criteria for a second financial institution controlling the second account, the second set of eligibility criteria being minimum requirements for a transfer of funds in to the second account. From operation 420, the flow proceeds to operation 430, which indicates to communicate, to an account owner of the first account, a transaction interface, the transaction interface satisfying the first and second sets of eligibility criteria. From operation 430, the flow in method 400 proceeds to the end oval.

FIG. 5 is a schematic diagram of computing system 500, hereinafter system 500, used in an exemplary embodiment of the present invention. The system 500 may be implemented by computing systems, networks, servers, or combinations thereof. The system 500 may include one or more processors 510 and memory 520. Memory 520 stores, in part, instructions and data for execution by processor 510. Memory 520 may store the executable code when in operation. The system 500 may further includes a mass storage device 530, portable storage device(s) 540, output devices 550, user input devices 560, a graphics display 570, and peripheral device(s) 580.

The components shown in FIG. 5 are depicted as being connected via a single bus 590. The components may be connected through one or more data transport means. Processor 510 and memory 520 may be connected via a local microprocessor bus, and the mass storage device 530, peripheral device(s) 580, portable storage device 540, and graphics display 570 may be connected via one or more input/output (I/O) buses.

Mass storage device 530, which may be implemented with a magnetic disk drive or an optical disk drive, is a non-volatile storage device for storing data and instructions for use by processor 510. Mass storage device 530 may store the system software for implementing embodiments of the present invention for purposes of loading that software into memory 520.

Portable storage device 540 operates in conjunction with a portable non-volatile storage medium, such as a floppy disk, compact disk, digital video disc, or USB storage device, to input and output data and code to and from the system. The system software for implementing embodiments of the present invention may be stored on such a portable medium and input to the system 500 via the portable storage device 540.

User input devices 560 provide a portion of a user interface. User input devices 560 may include one or more microphones, an alphanumeric keypad, such as a keyboard, for inputting alpha-numeric and other information, or a pointing device, such as a mouse, a trackball, stylus, or cursor direction keys. User input devices 560 may also include a touchscreen. Additionally, the system 500 as shown in FIG. 5 includes output devices 550. Suitable output devices include speakers, printers, network interfaces, and monitors.

Graphics display 570 may include a liquid crystal display (LCD) or other suitable display device. Graphics display 570 receives textual and graphical information, and processes the information for output to the display device.

Peripheral devices 580 may be included and may include any type of computer support device to add additional functionality to the computer system.

The components provided in the system 500 are those typically found in computer systems that may be suitable for use with embodiments of the present invention and are intended to represent a broad category of such computer components that are well known in the art. Thus, the system 500 may be a personal computer, hand held computing system, telephone, mobile computing system, workstation, server, minicomputer, mainframe computer, or any other computing system. The computer may also include different bus configurations, networked platforms, multi-processor platforms, etc. Various operating systems may be used including Unix, Linux, Windows, Mac OS, Palm OS, Android, iOS (known as iPhone OS before June 2010), QNX, and other suitable operating systems.

It is noteworthy that any hardware platform suitable for performing the processing described herein is suitable for use with the embodiments provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), Blu-ray Disc (BD), any other optical storage medium, RAM, PROM, EPROM, EEPROM, FLASH memory, and/or any other memory chip, module, or cartridge.

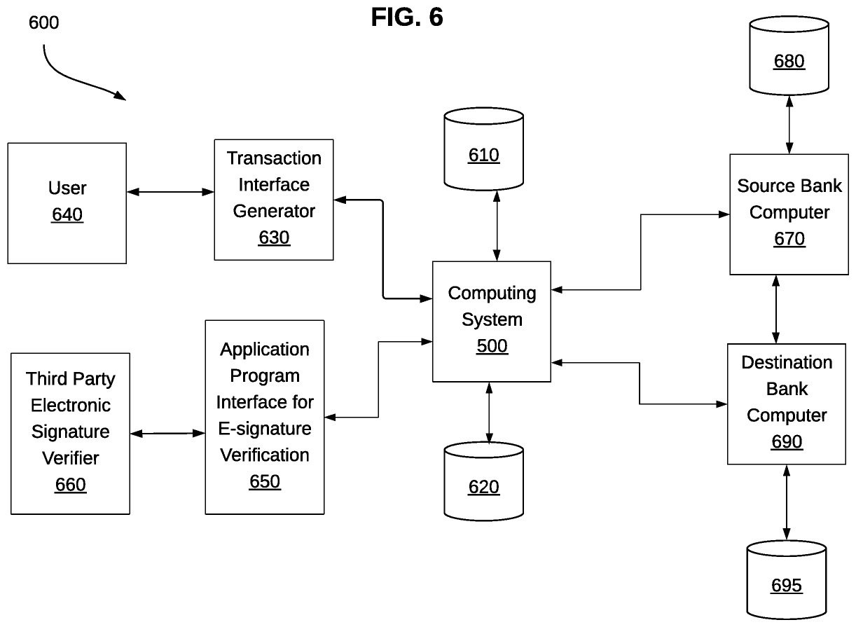

FIG. 6 is a schematic diagram of computing network 600 used in an exemplary embodiment of the present invention. Computing network 600, also referred to as network 600, includes computing system 500. Computing system 500 is coupled to database 610 which includes transfer-in requirements for various financial institutions, as well as database 620 which includes transfer-out requirements for various financial institutions. Computing system 500 is coupled to transaction interface generator 630, which is adapted to create a custom interface for user 640 based on the transfer-out requirements of a source custodian financial institution and the transfer-in requirements of a destination custodian financial institution. Transaction interface generator 630 is also adapted to communicate the custom interface to user 640 and to receive data input from user 640 to obtain information necessary to complete a transaction. Computing system 500 is also coupled to application program interface (API) for e-signature verification 650, which is communicates with third-party electronic signature verifier 660.

Computing system 500 is further coupled to source bank computer 670, which may access database 680 including transfer-in and transfer-out requirements for the financial institution associated with source bank computer 670. The financial institution associated with source bank computer 670 may be incentivized to push data to computing system 500 related to transfer-in and transfer-out requirements for the financial institution in relation to various account-type transactions. Alternatively, source bank computer 670 may respond to computing system 500 requests for information related to transfer-in and transfer-out requirements for the financial institution in relation to various account-type transactions.

Subscription to the transfer system and therefore access to other financial institutions minimum transfer requirements may require submission and maintenance of the corresponding financial institution's own minimum transfer requirements. Essentially, access may be provided in exchange for data.

Additionally or alternatively, a voting system may be used to indicate and flag quality issues for data. For example, if the transfer system initiates a transfer which fails due to the losing custodian minimum transfer requirements being inaccurate, the winning custodian may provide feedback to this effect. The system may flag the transfer minimum requirements as potentially inaccurate. If this situation happens multiple times (for example, 80% or more of transfers over a 30 day period, or on over 5 transfer requests), then the data for the losing custodian may be flagged as stale and the corresponding financial institution may be required to update their minimum transfer requirements before being allowed to continue to use the transfer system.

Computing system 500 is further coupled to destination bank computer 690, which may access database 695 including transfer-in and transfer-out requirements for the financial institution associated with destination bank computer 690. The financial institution associated with destination bank computer 690 may be incentivized to push data to computing system 500 related to transfer-in and transfer-out requirements for the financial institution in relation to various account-type transactions. Alternatively, destination bank computer 690 may respond to computing system 500 requests for information related to transfer-in and transfer-out requirements for the financial institution in relation to various account-type transactions.

The above description is illustrative and not restrictive. Many variations of the technology will become apparent to those of skill in the art upon review of this disclosure. The scope of the technology should, therefore, be determined not with reference to the above description, but instead should be determined with reference to the appended claims along with their full scope of equivalents.

What is claimed is:

1. A method of transferring funds from a first account to a second account, comprising:
determining dynamically a first set of eligibility criteria for a first financial institution controlling the first account, the first set of eligibility criteria being first minimum requirements for a transfer of funds out of the first account;
determining dynamically a second set of eligibility criteria for a second financial institution controlling the second account, the second set of eligibility criteria being second minimum requirements for a transfer of funds in to the second account; and
communicating, to an account owner of the first account, a transaction interface, the transaction interface satisfying the first and second sets of eligibility criteria.

2. The method of claim 1, wherein:
the operation of determining dynamically the first set of eligibility criteria includes periodically accessing a first database of the first financial institution; and
the operation of determining dynamically the second set of eligibility criteria includes periodically accessing a second database of the second financial institution.

3. The method of claim 1, wherein:
the operation of determining dynamically the first set of eligibility criteria includes periodically accessing a database of transfer-out requirements, the first financial institution being incentivized to update the database of transfer-out requirements; and
the operation of determining dynamically the second set of eligibility criteria includes periodically accessing a database of transfer-in requirements, the second financial institution being incentivized to update the database of transfer-in requirements.

4. The method of claim 1, wherein the operation of providing the transaction interface includes an indication of a requirement of at least one of a medallion signature guarantee, an e-signature, and a wet signature, the requirement being at least one of the first minimum requirements and the second minimum requirements.

5. The method of claim 4, wherein the requirement is of the e-signature, and further comprising accessing a third-party verification engine for verifying the e-signature.

6. The method of claim 1, wherein the operation of providing the transaction interface includes an indication of a requirement of at least one of an original and a fax.

7. The method of claim 1, further comprising receiving information input into the transaction interface by the account owner.

8. The method of claim 7, further comprising initiating a transfer of funds from the first account to the second account.

9. The method of claim 8, further comprising:
encrypting communications to the account owner;
encrypting communications from the account owner;
encrypting communications to the first financial institution; and
encrypting communications to the second financial institution.

10. The method of claim 1, wherein:
the first set of eligibility criteria includes a first amount threshold, a minimum holding period for the first account, a first set of qualifying account types of the first account, and a second set of qualifying account types of the second account; and
the second set of eligibility criteria includes a second amount threshold, a third set of qualifying account types of the first account and a fourth set of qualifying account types of the second account.

11. A system for transferring funds from a first account to a second account, comprising:
a first determining arrangement for determining dynamically a first set of eligibility criteria for a first financial institution controlling the first account, the first set of eligibility criteria being first minimum requirements for a transfer of funds out of the first account;
a second determining arrangement for determining dynamically a second set of eligibility criteria for a second financial institution controlling the second account, the second set of eligibility criteria being second minimum requirements for a transfer of funds in to the second account; and
a transaction interface generator adapted to generate a transaction interface satisfying the first and second sets of eligibility criteria, the transaction interface generator further adapted to communicate the transaction interface to an account owner of the first account.

12. The system of claim 11, further comprising:
a first database access arrangement adapted to periodically access a first database of the first financial institution to determine dynamically the first set of eligibility criteria; and
a second database access arrangement adapted to periodically access a second database of the second financial institution to determine dynamically the second set of eligibility criteria.

13. The system of claim 11, further comprising:
a first incentivizing arrangement for incentivizing the first financial institution to update a database of transfer-out requirements, the first determining arrangement periodically accessing the database of transfer-out requirements to determine dynamically the first set of eligibility criteria; and
a second incentivizing arrangement for incentivizing the second financial institution to update a database of transfer-in requirements, the second determining arrangement periodically accessing the database of transfer-in requirements to determine dynamically the second set of eligibility criteria.

14. The system of claim 11, wherein the transaction interface includes an indication of a requirement of at least one of a medallion signature guarantee, an e-signature, and a wet signature.

15. The system of claim 14, wherein the requirement is of the e-signature, and further comprising an application programming interface for accessing a third-party verification engine, the third-party verification engine for verifying the e-signature.

16. The system of claim 11, wherein the transaction interface includes an indication of a requirement of at least one of an original and a fax.

17. The system of claim 11, wherein:
information input into the transaction interface is received by the account owner; and
a transfer of funds from the first account to the second account is initiated.

18. The system of claim 11, wherein:
communications to the account owner are encrypted;
communications from the account owner are encrypted;
communications to the first financial institution are encrypted; and
communications to the second financial institution are encrypted.

19. The system of claim 11, wherein:
the first set of eligibility criteria includes a first amount threshold, a minimum holding period for the first account, a first set of qualifying account types of the first account, and a second set of qualifying account types of the second account; and
the second set of eligibility criteria includes a second amount threshold, a third set of qualifying account types of the first account and a fourth set of qualifying account types of the second account.

20. A non-transitory computer readable medium having stored thereon software instructions that, when executed by a processor, cause the processor to perform a method for transferring funds from a first account to a second account, the method comprising:
determining dynamically a first set of eligibility criteria for a first financial institution controlling the first account, the first set of eligibility criteria being first minimum requirements for a transfer of funds out of the first account, the first set of eligibility criteria including a first amount threshold, a minimum holding period for the first account, a first set of qualifying account types of the first account, and a second set of qualifying account types of the second account, the operation of determining dynamically the first set of eligibility criteria including periodically accessing a database of transfer-out requirements related to the first financial institution;
incentivizing the first financial institution to update the database of transfer-out requirements;
determining dynamically a second set of eligibility criteria for a second financial institution controlling the second account, the second set of eligibility criteria being second minimum requirements for a transfer of funds in to the second account, the second set of eligibility criteria including a second amount threshold, a third set of qualifying account types of the first account and a fourth set of qualifying account types of the second account, the operation of determining dynamically the second set of eligibility criteria including periodically accessing a database of transfer-in requirements related to the second financial institution;
incentivizing the second financial institution to update a database of transfer-in requirements;
communicating, to an account owner of the first account, a transaction interface, the transaction interface satisfying the first and second sets of eligibility criteria, the transaction interface including an indication of a requirement of an e-signature and of at least one of an original and a fax; and
receiving information input into the transaction interface by the account owner;
accessing a third-party verification engine for verifying the e-signature;
initiating a transfer of funds from the first account to the second account when the e-signature is verified by the third-party verification engine; and
encrypting communications to the account owner, communications from the account owner, communications to the first financial institution, and communications to the second financial institution.
